(19) United States
(12) Patent Application Publication
(10) Pub. No.: US 2011/0182493 A1
(43) Pub. Date: Jul. 28, 2011

(54) METHOD AND A SYSTEM FOR IMAGE ANNOTATION

(76) Inventors: Martin HUBER, Uttenreuth (DE); Michael Kelm, Erlangen (DE); Sascha Seifert, Konigsbach-Stein (DE)

(21) Appl. No.: 12/711,363

(22) Filed: Feb. 24, 2010

(30) Foreign Application Priority Data
Jan. 25, 2010 (EP) 10000730

(51) Int. Cl. G06K 9/00; G06K 9/34; G06F 3/048

(52) U.S. Cl. 382/132; 382/173; 715/764

(57) ABSTRACT

A method and a system are disclosed for image annotation of images, in particular two- and three-dimensional medical images. In at least one embodiment, the image annotation system includes an image parser which parses images retrieved from an image database or provided by an image acquisition apparatus and segments each image into image regions. The image can be provided by any kind of image acquisition apparatus such as a digital camera an x-ray apparatus, a computer tomograph or a magnetic resonance scanning apparatus. Each segmented image regions is annotated automatically with annotation data and stored in an annotation database. In at least one embodiment, the system includes at least one user terminal which loads at least one selected image from said image database and retrieved the corresponding annotation data of all segmented image regions of said image from said annotation database for further annotation of the image. The image annotation system, in at least one embodiment, allows for a more efficient and more reliable annotation of images which can be further processed to generate automatically reports for examples of patients in a hospital. The image annotation method and system according to at least one embodiment of the invention, can be used in a wide range of applications in particular of annotation of medical images but also in security systems as well as in the developments of prototypes of complex apparatuses such as automobiles.

### PRIORITY STATEMENT

The present application hereby claims priority under 35 U.S.C. §119 on German patent application number EP10000730 filed Jan. 25, 2010, the entire contents of which are hereby incorporated herein by reference.

### FIELD

At least one embodiment of the invention generally relates to a method and/or a system for image annotation of images in particular medical images.

### BACKGROUND

In many applications it is useful to annotate images such as medical images of patients. For example diagnosis and treatment planning for patients can be improved by comparing the patients images with clinical images of other patients with similar anatomical and pathological characteristics where the similarity is based on the semantic understanding of the image content. Further, a search in medical image databases can be improved by taking the content of the images into account. This requires the images to be annotated for example by labelling image regions of the image.

The conventional way to annotate images if that a user such as a doctor takes a look at medical images taken from a patient and speaks his comments into a dictaphone to be written by a secretary as annotation text data and stored along with the image in an image database. Another possibility is that the user or doctor himself types the annotation data in a word document stored along with the image in a database. The clinician or doctor is writing natural language reports to describe the image content of the respective image. This conventional way of annotating images has several drawbacks.

The conventional annotation method is time consuming and error prone. Furthermore, every doctor can use his own vocabulary for describing the image content so that the same image can be described by different doctors or users very differently with a different vocabulary.

Another disadvantage is that a user performing the annotation cannot use already existing annotation data so that the annotation of an image can take a lot of time and is very inefficient. Another drawback is that the natural language used by the doctor annotating the image is his own natural language such as German or English. This can cause a language barrier if the clinicians or doctors have different natural languages. For example annotation data in German can only be used by few doctors in the United States or Great Britain.

Furthermore, annotating is an interactive task consuming extensive clinician time and cannot be scaled to large amounts of imaging data in hospitals. On the other hand automated image analysis while being very scalable does not leverage standardized semantics and thus cannot be used across specific applications. Since the clinician is writing natural language reports to describe the image content of the respective image a direct link with the image content lacks. Often common vocabulary from biomedical and ontology is used, however the labelling is still manual, time consuming and therefore not accepted by users.

### SUMMARY

Accordingly, at least one embodiment of the present invention provides a method and/or a system for image annotation which overcomes at least one of the above-mentioned drawbacks and which provides an efficient way of annotating images.

At least one embodiment of the invention provides an image annotation system for annotation of images comprising:
(a) an image parser which parses images retrieved from an image database or provided by an image detection apparatus and segments each image into image regions, wherein each segmented image region is annotated automatically with annotation data and stored in a annotation database; and
(b) at least one user terminal which loads at least one selected image from said image database and retrieves the corresponding annotation data of all segmented image regions of said image from said annotation database for further annotation of said image.

The image annotation system according to at least one embodiment of the present invention increases the efficiency of annotation by using an image parser which can be run on an image parsing system.

The image annotation system can be used for annotation of any kind of images in particular medical images taken from a patient.

The image annotation system according to at least one embodiment of the present invention can be used also used for annotating other kinds of images such as images taken from complex apparatuses to be developed or images to be evaluated by security systems.

In a possible embodiment of the image annotation system according to the present invention the image database stores a plurality of two-dimensional or three-dimensional images.

In a possible embodiment of the image annotation system according to the present invention the image parser segments the image into disjoint image regions each being annotated with at least one class or relation of a knowledge database.

In a possible embodiment of the image annotation system according to the present invention the knowledge database stores linked ontologies comprising classes and relations.

In a possible embodiment of the image annotation system according to the present invention the image parser segments the image by means of trained detectors provided to locate and delineate entities of the image.

In a possible embodiment of the image annotation system according to the present invention annotation data of the image is updated by way of the user terminal by validation, removal or extension of the annotation data retrieved from the annotation database of the image parser.

In a possible embodiment of the image annotation system according to the present invention each user terminal has a graphical user interface comprising input means for performing an update of annotation data of selected image regions of the image or for marking image regions and output means for displaying annotation data of selected image regions of the image.

In a possible embodiment of the image annotation system according to the present invention the user terminal comprises context support means which associate automatically an image region marked by a user with an annotated image region, said annotated image region being located inside the marked image region or the marked region being located within the annotated image region or if no matching annotated image region can be found, it can be associated with the closest nearby annotated image region.

In a possible embodiment of the image annotation system according to the present invention the knowledge database stores Radlex-ontology data, foundational model of anatomy ontology data or ICD10-ontology data.

In a possible embodiment of the image annotation system according to the present invention the image database stores a plurality of two- or three-dimensional images, said images comprising:

magnetic resonance image data provided by a magnetic resonance detection apparatus,
computer tomography data provided by a computer tomograph apparatus,
x-ray image data provided by an x-ray apparatus,
ultrasonic image data provided by an ultrasonic detection apparatus or photographic data provided by a digital camera.

In a possible embodiment of the image annotation system according to the present invention the annotation data stored in the annotation database comprises text annotation data (classes and relation names coming from said ontologies) indicating an entity represented by the respective segmented image region of the image.

In a possible embodiment of the image annotation system according to the present invention the annotation data further comprises parameter annotation data indicating at least one physical property of an entity represented by the respective segmented image region of the image.

In an embodiment of the image annotation system according to the present invention the parameter annotation data comprises a chemical composition, a density, a size or a volume of an entity represented by the respective segmented image region of said image.

In a possible embodiment of the image annotation system according to the present invention the annotation data further comprises video and audio annotation data of an entity represented by the respective segmented image region of the image.

In a possible embodiment of the image annotation system according to the present invention the image database stores a plurality of two-dimensional or three-dimensional medical images which are segmented by means of trained detectors of said image parser into image regions each representing at least one anatomical entity of a human body of a patient.

In an embodiment of the image annotation system according to the present invention the anatomical entity comprises a landmark point, an area or a volume or organ within a human body of a patient.

In an embodiment of the image annotation system according to the present invention the annotated data of at least one image of a patient is processed by a data processor unit to generate automatically an image finding record of said image.

In an embodiment of the image annotation system according to the present invention the image finding records of images taken from the same patient are processed by the data processing unit to generate automatically a patient report of the patient.

In an embodiment of the image annotation system according to the present invention the image database stores a plurality of photographic data provided by digital cameras, wherein the photographic images are segmented by means of trained detectors of the image parser into image regions each representing a physical entity.

At least one embodiment of the invention further provides an image annotation system for annotation of medical images of patients, said system comprising:
(a) a processing unit for executing an image parser which parses medical images of a patient retrieved from an image database and segments each medical image by means of trained detectors into image regions wherein each segmented image region is annotated automatically with annotation data and stored in an annotation database; and
(b) at least one user terminal connected to the processing unit, said user terminal loading at least one selected medical image from said image database and retrieves the corresponding annotation data of all segmented image regions of said medical image from said annotation database for further annotation of said medical image of said patient.

At least one embodiment of the invention further provides an apparatus development system for development of at least one complex apparatus having a plurality of interlinked entities said development system comprising an image annotation system for annotation of images comprising:
(a) an image parser which parses images retrieved from an image database or provided by an image detection apparatus and segments each image into image regions, wherein each segmented image region is annotated automatically with annotation data and stored in a annotation database; and
(b) at least one user terminal which loads at least one selected image from said image database and retrieves the corresponding annotation data of all segmented image regions of said image from said annotation database for further annotation of said image.

At least one embodiment of the invention further provides a security system for detecting at least one entity within images, said security system having an image annotation system for annotation of images comprising:
(a) an image parser which parses images retrieved from an image database or provided by an image detection apparatus and segments each image into image regions, wherein each segmented image region is annotated automatically with annotation data and stored in a annotation database; and
(b) at least one user terminal which loads at least one selected image from said image database and retrieves the corresponding annotation data of all segmented image regions of said image from said annotation database for further annotation of said image.

At least one embodiment of the invention further provides a method for annotation of an image comprising the steps of:
(a) parsing an image retrieved from an image database and segmenting said retrieved image by means of trained detectors into image regions, wherein each segmented image region is annotated automatically with annotation data and stored in an annotation database; and
(b) selecting an image from said image database and retrieving the corresponding annotation data of all segmented image regions of said image from said annotation database for further annotation of said selected image.

At least one embodiment of the invention further provides an annotation tool for annotation of an image, said annotation tool loading at least one selected image from an image database and retrieving corresponding annotation data of segmented image region of said image from an annotation database for further annotation.

At least one embodiment of the invention further provides a computer program comprising instructions for performing such a method.

At least one embodiment of the invention further provides a data carrier which stores such a computer program.

### BRIEF DESCRIPTION OF THE ENCLOSED FIGURES

In the following possible embodiments of the system and method for performing image annotation are described with reference to the enclosed figures:

FIG. 1 shows a diagram of a possible embodiment of an image annotation system according to the present invention;

FIG. 2 shows a flow chart of a possible embodiment of an image annotation method according to the present invention;

FIG. 3 shows a block diagram of a possible embodiment of an image annotation system according to the present invention;

FIG. 4 shows an example image annotated by the image annotation system according to an embodiment of the present invention;

FIG. 5 shows a further example image annotated by the image annotation system according to an embodiment of the present invention;.

FIG. 6 shows a further example image annotated by the image annotation system according to an embodiment of the present invention;

FIG. 7 shows a diagram for illustrating a possible embodiment of a security system using the image annotation system according to an embodiment of the present invention;

FIG. 8 shows an example image annotated by the image annotation system used in the security system of FIG. 7.

### DETAILED DESCRIPTION OF THE EXAMPLE EMBODIMENTS

Various example embodiments will now be described more fully with reference to the accompanying drawings in which only some example embodiments are shown. Specific structural and functional details disclosed herein are merely representative for purposes of describing example embodiments. The present invention, however, may be embodied in many alternate forms and should not be construed as limited to only the example embodiments set forth herein.

Accordingly, while example embodiments of the invention are capable of various modifications and alternative forms, embodiments thereof are shown by way of example in the drawings and will herein be described in detail. It should be understood, however, that there is no intent to limit example embodiments of the present invention to the particular forms disclosed. On the contrary, example embodiments are to cover all modifications, equivalents, and alternatives falling within the scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the present invention. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments of the invention. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors used herein are interpreted accordingly.

Although the terms first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region, layer, or section. Thus, a first element, component, region, layer, or section discussed below could be termed a second element, component, region, layer, or section without departing from the teachings of the present invention.

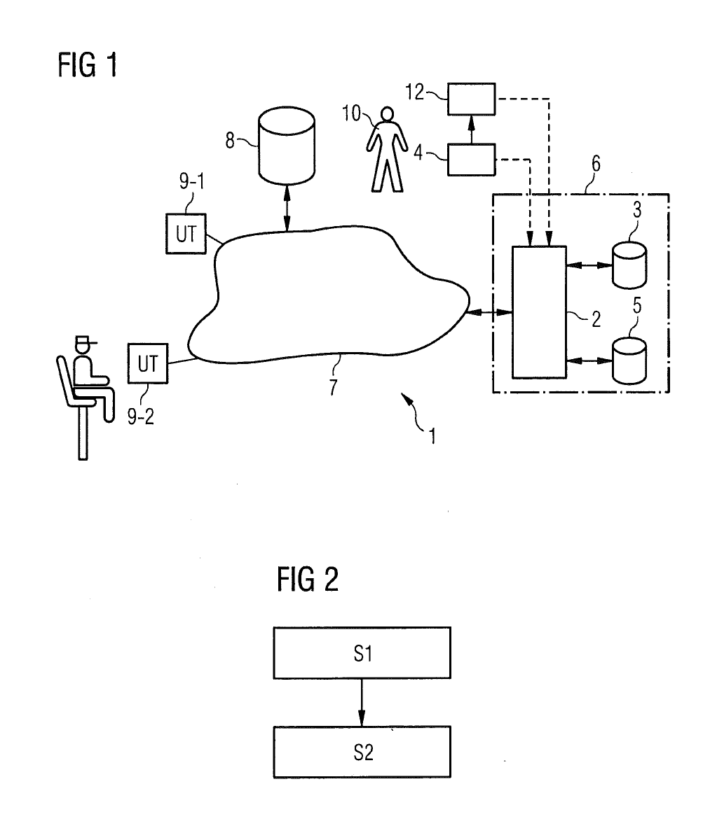

As can be seen from FIG. 1 an image annotation system 1 according to the present invention comprises in the shown embodiment an image parser 2 which parses images retrieved from an image database 3 or provided by an image acquisition apparatus 4. The image parser 2 segments each image into image regions wherein each segmented image region is annotated automatically with annotation data and stored in an annotation database 5. The image parser 2 can be formed by a server or computer running an image parser application. The server 2, the image database 3 and the annotation database 5 can form an integrated image parsing system 6 as shown in FIG. 1.

The image acquisition apparatus 4 connected to the image parser 2 can be formed by a conventional digital camera or other image acquisition apparatuses, in particular a magnetic resonance detection apparatus, a computer tomograph apparatus, an x-ray apparatus or an ultrasonic machine. The magnetic resonance image data provided by a magnetic resonance scanning apparatus, the computer tomography data provided by a computer tomograph apparatus, the x-ray image data provided by an x-ray apparatus, the ultrasonic data provided by an ultrasonic machine and the photographic data provided by a digital camera are supplied to the image parser 2 of the image parsing system 6 and stored in the image database 3 for annotation.

The image database 3 can store a plurality of two-dimensional or three-dimensional images of the same or different type. The image parsing system 6 is connected via a network 7 to a knowledge database 8. The knowledge database 8 stores at least one ontology or several linked ontologies comprising classes and relations. Further, the image annotation system 1 according to the present invention comprises at least one user terminal 9-i which loads at least one selected image from the image database 3 and retrieves the corresponding annotation data of all segmented image regions of the image from the annotation database 5 for further annotation of the image. The user terminals can be a client computer that is connected to a local area or a wide area network 7. In a possible embodiment the user terminals 9-i and the knowledge database 8 and the image parsing system 6 are connected to the internet forming the network 7.

In the embodiment shown in FIG. 1 the image acquisition apparatus 4 such as a magnetic resonance scanning apparatus, a computer tomograph apparatus an x-ray apparatus or a ultrasonic machine takes one or several pictures or images of a patient 10 to be annotated. This annotation can be performed by a doctor 11 working at the user terminal 9-2 as shown in FIG. 1.

The image parsing system 6 as shown in FIG. 1 can form a background system performing the generation, retrieving and segmenting of each image into image regions in the background. In a possible embodiment the image parsing system 6 can further comprise a data management unit. The image parsing system 6 loads the images, parses the image and stores the images via the data management unit to the annotation database 5. This can be performed in the background and offline. In the next online step the user such as the user 11 shown in FIG. 1 loads this data stored in the annotation database 5 and performs a further annotation of the respective image. The user 11 can load at least one selected image from the image database 3 and retrieve the corresponding annotation data of all segmented image regions of the respective image from the annotation database 5 for further annotation of the image. By using an annotation tool the annotation data of the respective image can be updated by the user 11 by means of the user terminal 9-2 by validation, removal or extension of the annotation data retrieved from the annotation database 5 of the image parsing system 6. The user terminal 9-i can have a graphical user interface (GUI) comprising input means for performing an update of the annotation data of selected image regions of the image or for marking image regions. The graphical user interface can further comprise output means for displaying annotation data of selected image regions of the respective image. The user terminal 9-i can be connected to the network 7 via a wired or wireless link. The user terminal 5-i can be a laptop but also a smartphone.

In a possible embodiment the user 11 terminal 9-i can comprise context support means which associate automatically an image region marked by a user with an annotated image region wherein the annotated image region can be located inside the marked image region or the marked image region can be located within the annotated image region or if no matching annotated image region can be found, it can be associated with the closest nearby annotated image region.

In a medical application the knowledge database 8 can store Radlex-ontology data, foundational model of anatomy ontology data or ICD10 ontology data. The knowledge database 8 can be connected as shown in FIG. 1 via the network 7 to the image parsing system 6. In an alternative embodiment the knowledge database 8 is directly connected to the image parser 2. In a possible embodiment the several knowledge databases 8 can be provided within the image annotation system 1 according to the present invention.

An ontology includes classes and relations. These are formed by predefined text data such as “heart”, i.e. does designate an entity. A relation, for instance, indicates whether one organ is located e.g. “above” another organ, for example, an organ A is located above organ B. Classes of ontologies are called also concepts and relations of ontologies are sometimes also called slots. By using such ontologies it is for example possible to use application programs which can automatically verify a correctness of a statement within a network of interrelated designations. Such a program can for instance verify or check whether an organ A can possibly be located above another organ B i.e. a consistency check of annotation data can be reformed. This consistency check can disclose inconsistencies or hidden inconsistencies between annotation data so that a feedback to the annotating person can be generated. Furthermore, it is possible by providing further rules or relations to generate additional knowledge data which can be added for instance in case of a medical ontology later. In a possible embodiment the system can by itself detect that an entity has a specific relation to another entity. For example, the system might find out that organ A has to be located above another organ B by deriving this knowledge or relation from other relations.

For a text annotation data primarily predefined texts of the ontologies can be used. By this multi-linguality or generation of further knowledge a broader use of the annotated images is possible. For example, it is possible that in the future a further ontology is added which describes a specific disease which is connected to the existing ontologies. In this case it is possible to find images of patients relating to this specific disease, which might have not been known at the time when the annotation was performed.

The image parser 2 segments an image into disjoint image regions each image being annotated with at least one class or relation of the knowledge database 8. The image parser 2 segments the image by means of trained detectors provided to locate and delineate entities of the respective image. The detectors can be trained by means of a plurality of images of the same entity such as an organ of the human body. For example, a detector can be trained by a plurality of images showing hearts of different patients so that the detector can recognize after the training a heart within a thorax picture of a patient.

The annotation data stored in an annotation database 5 can comprise text annotation data indicating an entity represented by the respective segmented image region of the image. In a possible embodiment the annotation data not only comprises text annotation data, e.g., defined texts coming from said ontologies, but comprises also parameter annotation data indicating at least one physical property of an entity represented by the respective segmented image region of the image. Such parameter annotation data can comprise for example a chemical composition, a density, a size or a volume of an entity represented by the respective segmented image region of the image. The annotation data in particular the parameter annotation data can either be input by the user such as the doctor 11 shown in FIG. 1 or generated by a measurement device 12 measuring for example the density, size or volume of an anatomical entity within a human body of a patient 10. In FIG. 1 the parameter annotation data can be generated by a medical measurement device 12 connected to the image parser 2 of the image parsing system 6. The measuring device 12 can generate the parameter annotation data either directly by measuring the respective parameter of the patient 10 or by evaluating the picture or image taken by the image acquisition apparatus 4. For example the user 11 can mark an image region in the taken picture and the measurement device 12 can for example measure the size or volume of the respective anatomical entity such as an organ of the patient 10. The marking of an image region within the image of the patient 10 can be done by the user, i.e. the doctor 11 as shown in FIG. 1 or performed automatically.

In a further possible embodiment the annotation data does not only comprise text annotation data or parameter annotation data but also video and audio annotation data of an entity represented by the respective segmented image region of the image.

In a possible embodiment the image database 3 stores a plurality of two- or three-dimensional images of a patient 10 which are segmented by means of trained detectors of the image parser 2 into image regions each representing at least one anatomical entity of the human body of the patient 10. These anatomical entities can for example comprise landmarks, areas or volumes or organs within a human body of the patient 10.

The annotated data of at least one image of a patient 10 such as shown in FIG. 1 can be processed by a data processing unit (not shown in FIG. 1) to generate automatically an image finding record of the respective image. The generation of the image finding record can in a possible embodiment be performed by a data processing unit of the user terminal 9-I or the image parsing system 6. In a possible embodiment several image finding records of images taken from the same patient 10 can be processed by the data processing unit to generate automatically a patient report of the patient 10. These images can be of the same or different types. For example the annotation data of a computer tomography image, a magnetic resonant image and an x-ray image can be processed separately by the data process unit to generate automatically corresponding image finding records of the respective images. These image finding records can then be processed further to generate automatically a patient report of the patient 10.

The terms of the annotation data or annotated data are derived from ontologies stored in the knowledge database 8. The terms can be the names of classes within the ontology such as the Radlex ontology. Each entity such as an anatomical entity has a unique designation or corresponding term. In a possible embodiment a finding list is stored together with the image region information data in the annotation database 5.

FIG. 1 shows an application of the image annotation system for annotating medical images of a patient 10. The image annotation system 1 according an embodiment of to the present invention can also be used for other applications for example for security systems or for annotating complex apparatuses to be developed such as prototypes. In these applications the image acquisition apparatus 4 does not generate an image of a patient 10 but for example of a complex apparatus having a plurality of interlinked electromechanical entities or for example of luggage of a passenger at an airport.

FIG. 2 shows a flow chart of a possible embodiment of a method for annotation of an image according to the present invention.

In first step S1 an image retrieved from an image database 3 is parsed and segmented by means of trained detectors into image regions. Each segmented image region is annotated automatically with annotation data and stored in the annotation database 5.

In a further step S2 for an image selected from the image database 3 annotation data of all segmented image regions of the image is retrieved from the annotation database 5 for further annotation of the selected image.

The parsing of the image in step S1 is performed by the image parser 2 of the annotation system 1 as shown in FIG. 1. The image is for example a two- or three-dimensional image. The selection of the image for further annotation can be performed for example by a user such as a doctor 11 as shown in FIG. 1.

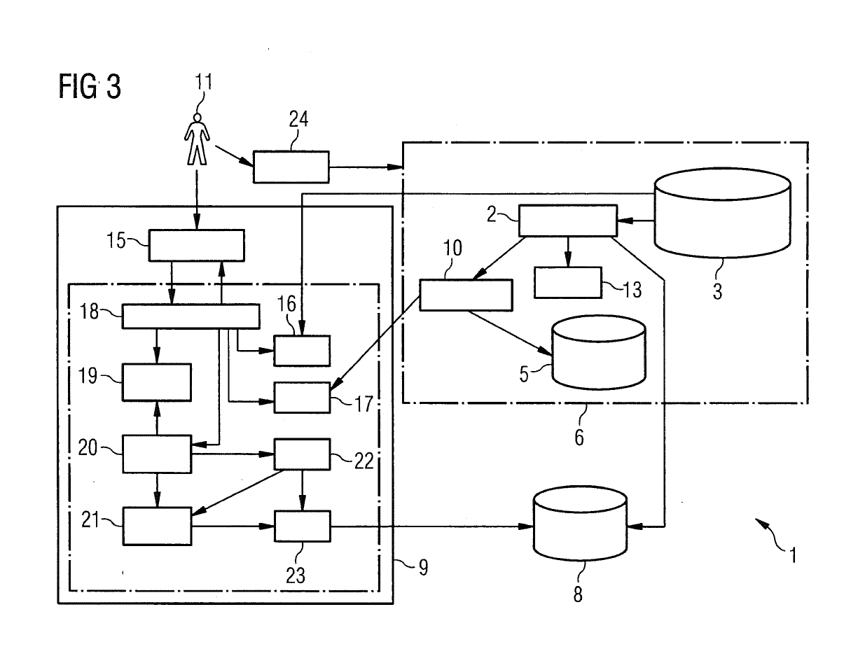

FIG. 3 shows a possible embodiment of an image annotation system 1 according to the present invention. The image parser 2 within the image parsing system 6 starts to load and parse images derived from the image database 3 i.e. a PACS-system. This can be done in an offline process. The image parser 2 automatically segments the image into disjoint image regions and labels them for example with concept names derived from the knowledge database 8 e.g. by the use of a concept mapping unit 13 as shown in FIG. 3. The image parser 2 makes use of detectors specifically trained to locate and delineate entities such as anatomical entities, e.g. a liver, a heart or lymph knots etc. An image parser 2 which can be used, is for example described in S. Seifert, A. Barbu, K. Zhou, D. Liu, J. Feulner, M. Huber, M. Suehling, A. Cavallaro und D. Comaniciu: “Hierarchical parsing and semantic navigation of fully body CT data, STIE 2009, the entire contents of which are hereby incorporated herein by reference. The image annotations i.e. the labelled image regions are stored then in the annotation database 5. The access to these databases can be mediated by a data management unit 14 which enables splitting and caching of queries. According to the embodiment showing in FIG. 3, an image parsing system 6 can comprise an image parser 2, an image database 3, an annotation database 5 and additionally a concept mapping unit 13 as well as a data management unit 14.

The user terminal 9-i as shown in FIG. 3 comprises a graphical user interface 15 which enables the user 11 to start and control the annotation process. A semantic annotation tool can load an image from a patient study through an image loader unit 16 from the image database 3. Simultaneously an annotation IO-unit 17 invoked by a controller 18 starts to retrieve the appropriate annotation data by querying. Subsequently, the controller 18 controls an annotation display unit 19 to adequately visualize the different kinds of annotation data such as ontology data, segmented organs, landmarks or other manually or automatically specified image regions of the respective image. Then the user 11 such as a doctor can validate, remove or extend the automatically generated image annotation. The update can be controlled by an annotation update unit 20.

The efficiency of a manual annotation process can be increased by using automatisms realized by a context support unit 21. The context support unit 21 can automatically label image regions selected by the user 11. If the user 11 marks an image region within an already defined image region the context support unit 21 can automatically associate it with the annotation data of the outer image regions. This image region can be generated by the image parsing system 6 or specified by the user 11. In the same manner the context support unit 21 can associate a marked image region outside of any other image region with the nearest already annotated image region. The system 1 also enabled the user 11 to label arbitrary manually specified image regions. Since knowledge databases 8, for example in medical applications, can have a high volume a semantic filter unit 22 can be provided which schedules information about the current context from the context support unit 21, i.e. the current image regions. The semantic filter unit 14 can return a filtered, context related list of probable class and relation names coming ontology. In a possible embodiment the context support unit 21 and the semantic filter unit 14 do not directly query the knowledge database 8 but the use of a mediator instance, i.e. a knowledge access unit 23 which enables more powerful queries using high level inference strategies. In a possible embodiment for controlling the image parsing system 6, a maintenance unit 24 can be provided. The image annotation system 1 as shown in FIG. 3 provides a context sensitive, semiautomatic image annotation system. The system 1 combines image analysis based on machine learning and semantics based on symbolic knowledge. The integrated system, i.e. the image parsing system and the context support unit enable a user 11 to annotate with much higher efficiency and give him the possibility to post process the data or use the data in a semantic search in image databases.

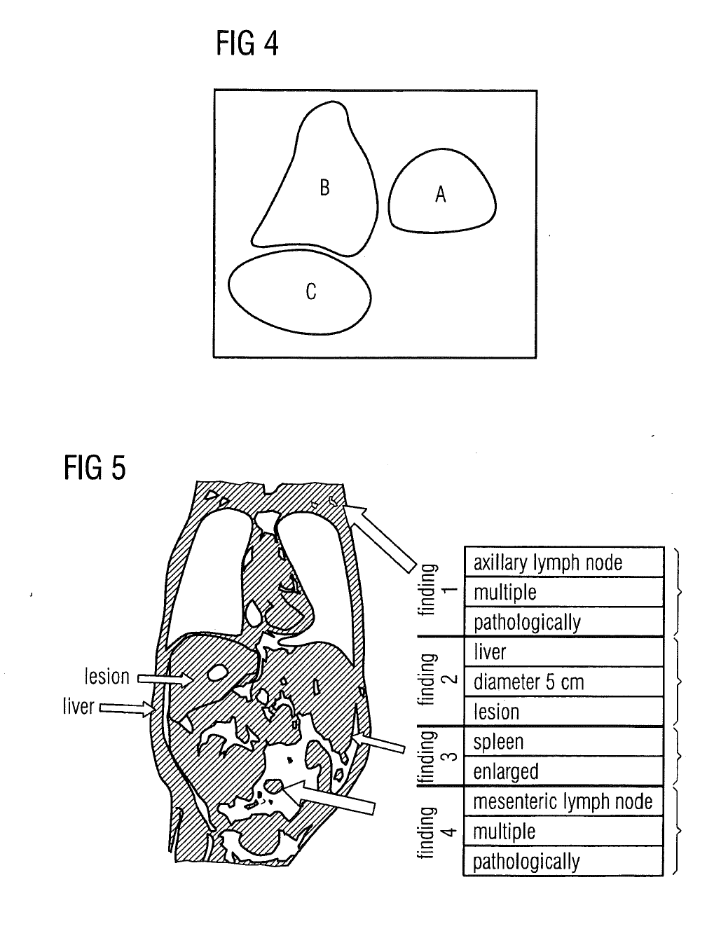

FIG. 4 shows an example image for illustrating an application of the image annotation system 1 according to an embodiment of the present invention. FIG. 4 shows a thorax picture of a patient 10 comprising different anatomical entities such as organs in particular an organ A, an organ B and an organ C. The image shown in FIG. 4 can be segmented into image regions wherein each segmented image region is annotated automatically with annotation data and stored in an annotation database. The image parser segments the image into disjoint image regions each being annotated with at least one class or relation of a knowledge database. The image shown in FIG. 4 by way of trained detectors provided to locate and delineate entities of the respective image.

For example the image parser 2 can segment the image by way of trained detectors for an organ A, B, C to locate and delineate these anatomical images. Accordingly, in this simple example shown in FIG. 4 three segmented image regions for organs A, B, C can be generated and annotated separately with annotation data stored in an annotation database 5. A user working at a user terminal 9-i can load at least one selected image such as shown in FIG. 4 from the image database 3 and retrieve the corresponding already existing annotation data of all segmented image regions A, B, C of said image from the annotation database 5 for further annotation of the image. In the simple example shown in FIG. 4 the anatomical entities are formed by organs A, B, C. The anatomic entities can also be formed by landmarks or points such as the end of a bone or any other regions in the human body.

FIG. 5 shows a further example image along with a finding list of said image. The findings are generated by the image parser 2 using for example trained software detectors. The image parser 2 recognizes image regions and annotates them using information taken from the knowledge database 8. In the given example of FIG. 5 there are four findings in the respective image and the user i.e. the doctor 11 can extend the finding list with his own annotation data. In the given example of FIG. 5 the image is a three-dimensional medical image of a patient acquired by a computer tomograph. In a possible embodiment the annotation data in the finding list can be logically linked to each other, for example by using logical Boolean operators.

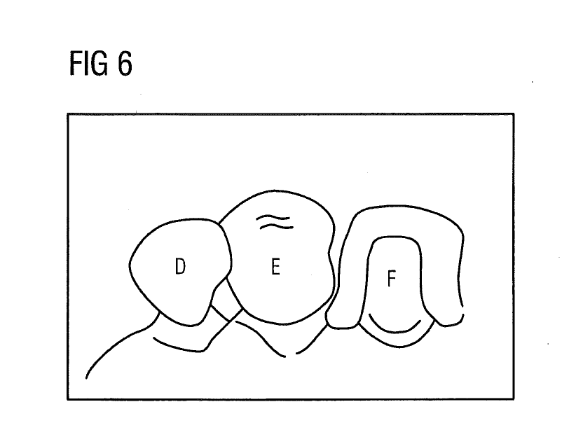

FIG. 6 shows a further example image which can be annotated by using the image annotation system 1 according to an embodiment of the present invention. In this application the image is a conventional image taken by a digital camera, for example during a holiday. The entities shown in the image are faces of different persons D, E, F and a user can use the image annotation system 1 according to the present invention to annotate the taken picture for his photo album. An image parser 2 can segment the image by means of trained detectors to locate and delineate entities in the image such as specific faces of persons or family members. In a possible embodiment the image shown in FIG. 6 can show different persons D, E, F photographed by a digital camera of a security system to add annotation data to a specific person by security personal.

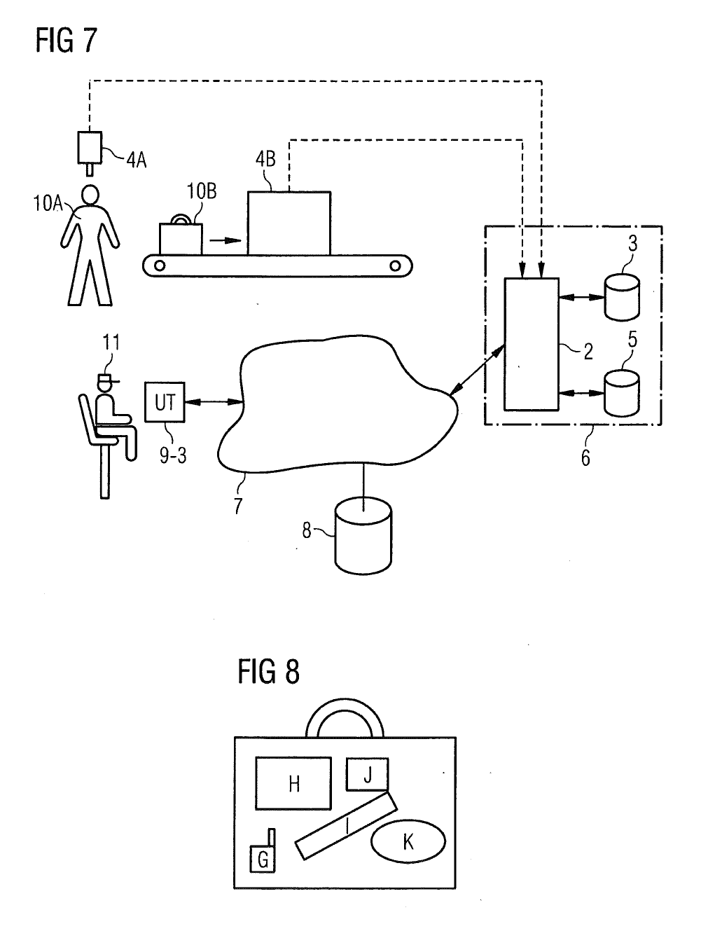

FIG. 7 shows a security system employing annotation system 1 according to an embodiment of the present invention. The security system shown in FIG. 7 comprises two image detection apparatuses 4A, 4B wherein the first image detection apparatus 4A is a digital camera taking pictures of a person 10A and the second image detection apparatus 4B is a scanner scanning luggage 10B of the person 10A. FIG. 8 shows an image of the content within the luggage 10B generated by the scanner 4B. The shown suitcase of the passenger 10A includes a plurality of entities G, H, I, J, K which can be annotated by a user such as security personal working at user terminal 9-3 as shown in FIG. 7.

The image annotation system 1 according to an embodiment of the present invention can also be used in the process of development of a complex apparatus or prototype comprising a plurality of interlinked electromechanical entities. Such a complex apparatus can be for example a prototype of a car or automobile. Accordingly, the image annotation system 1 can be used in a wide range of applications such as annotation of medical images but also in security systems or development systems.

The patent claims filed with the application are formulation proposals without prejudice for obtaining more extensive patent protection. The applicant reserves the right to claim even further combinations of features previously disclosed only in the description and/or drawings.

The example embodiment or each example embodiment should not be understood as a restriction of the invention. Rather, numerous variations and modifications are possible in the context of the present disclosure, in particular those variants and combinations which can be inferred by the person skilled in the art with regard to achieving the object for example by combination or modification of individual features or elements or method steps that are described in connection with the general or specific part of the description and are contained in the claims and/or the drawings, and, by way of combineable features, lead to a new subject matter or to new method steps or sequences of method steps, including insofar as they concern production, testing and operating methods.

References back that are used in dependent claims indicate the further embodiment of the subject matter of the main claim by way of the features of the respective dependent claim; they should not be understood as dispensing with obtaining independent protection of the subject matter for the combinations of features in the referred-back dependent claims. Furthermore, with regard to interpreting the claims, where a feature is concretized in more specific detail in a subordinate claim, it should be assumed that such a restriction is not present in the respective preceding claims.

Since the subject matter of the dependent claims in relation to the prior art on the priority date may form separate and independent inventions, the applicant reserves the right to make them the subject matter of independent claims or divisional declarations. They may furthermore also contain independent inventions which have a configuration that is independent of the subject matters of the preceding dependent claims.

Further, elements and/or features of different example embodiments may be combined with each other and/or substituted for each other within the scope of this disclosure and appended claims.

Still further, any one of the above-described and other example features of the present invention may be embodied in the form of an apparatus, method, system, computer program, computer readable medium and computer program product. For example, of the aforementioned methods may be embodied in the form of a system or device, including, but not limited to, any of the structure for performing the methodology illustrated in the drawings.

Even further, any of the aforementioned methods may be embodied in the form of a program. The program may be stored on a computer readable medium and is adapted to perform any one of the aforementioned methods when run on a computer device (a device including a processor). Thus, the storage medium or computer readable medium, is adapted to store information and is adapted to interact with a data processing facility or computer device to execute the program of any of the above mentioned embodiments and/or to perform the method of any of the above mentioned embodiments.

The computer readable medium or storage medium may be a built-in medium installed inside a computer device main body or a removable medium arranged so that it can be separated from the computer device main body. Examples of the built-in medium include, but are not limited to, rewriteable non-volatile memories, such as ROMs and flash memories, and hard disks. Examples of the removable medium include, but are not limited to, optical storage media such as CD-ROMs and DVDs; magneto-optical storage media, such as MOs; magnetism storage media, including but not limited to floppy disks (trademark), cassette tapes, and removable hard disks; media with a built-in rewriteable non-volatile memory, including but not limited to memory cards; and media with a built-in ROM, including but not limited to ROM cassettes; etc. Furthermore, various information regarding stored images, for example, property information, may be stored in any other form, or it may be provided in other ways.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. An image annotation system for annotation of images, comprising:
an image parser to parse images retrieved from an image database or provided by an image acquisition apparatus and to segment each image into image regions, each segmented image region being annotated automatically with annotation data and stored in an annotation database; and
at least one user terminal to load at least one selected image from said image database and to retrieve corresponding annotation data of all segmented image regions of said at least one selected image from said annotation database for further annotation of said at least one selected image.

2. The image annotation system according to claim 1, wherein said image database stores a plurality of two-dimensional or three-dimensional images.

3. The image annotation system according to claim 1, wherein said image parser is further useable to segment each said image into disjoint image regions, each being annotated with at least one class or relation of a knowledge database.

4. The image annotation system according to claim 3, wherein said knowledge database stores linked ontologies comprising classes and relations.

5. The image annotation system according to claim 3, wherein said image parser is further useable to segment each said image by way of trained detectors provided to locate and delineate entities of each said image.

6. The image annotation system according to claim 1, wherein an annotation data of said image is updated by way of said user terminal by validation, removal or extension of the annotation data retrieved from said annotation database of said image parser.

7. The image annotation system according to claim 1, wherein said user terminal has a graphical user interface (GUI) comprising:
at least one input device for performing an update of annotation data of selected image regions of said image or for marking image regions, and
at least one output device for displaying annotation data of selected image regions of said image.

8. The image annotation system according to claim 1, wherein said user terminal comprises at least one context support device which associates automatically an image region marked by a user with an annotated image region, said annotated image region being located inside the marked image region or the marked region being located within said annotated image region or if no matching annotated image region can be found, it can be associated with the closest nearby annotated image region.

9. The image annotation system according to claim 4, wherein said knowledge database stores Radlex-ontology data, foundational model of anatomy ontology data or ICD 10 ontology data.

10. The image annotation system according to claim 2, wherein said image database stores a plurality of two-dimensional or three-dimensional images, said images comprising:
magnetic resonance image data provided by a magnetic resonance scanning apparatus,
computer tomography data provided by a computer tomograph apparatus,
x-ray image data provided by an x-ray apparatus,
ultrasonic image data provided by a ultrasonic machine, or
photographic data provided by a camera.

11. The image annotation system according to claim 1, wherein said annotation data stored in said annotation database comprises text annotation data indicating an entity represented by the respective segmented image region of said image.

12. The image annotation system according to claim 11, wherein said annotation data further comprises parameter annotation data indicating at least one physical property of an entity represented by the respective segmented image region of said image.

13. The image annotation system according to claim 12, wherein said parameter annotation data comprises a chemical composition, a density, a size or a volume of an entity represented by the respective segmented image region of said image.

14. The image annotation system according to claim 11, wherein said annotation data further comprises video and audio annotation data of an entity represented by the respective segmented image region of said image.

15. The image annotation system according to claim 2, wherein said image database stores a plurality of two-dimensional or three-dimensional medical images which are segmented by way of trained detectors of said image parser into image regions each representing at least one anatomical entity of a human body of a patient.

16. The image annotation system according to claim 15, wherein said anatomical entity comprises a land mark point, an area or a volume or organ within a human body of a patient.

17. The image annotation system according claims 15, wherein the annotated data of at least one image of a patient is processed by a data processing unit to generate automatically an image finding record of said image.

18. The image annotation system according to claim 17, wherein the image finding records of images taken from the same patient are processed by said data processing unit to generate automatically a patient report of said patient.

19. The image annotation system according to claim 2, wherein said image database stores a plurality of photographic image data provided by digital cameras, wherein said photographic images are segmented by way of trained detectors of said image parser into image regions each representing a physical entity.

20. An image annotation system for annotation of medical images of patients, said system comprising:
a processing unit for executing an image parser to parse medical images of a patient retrieved from said image database and to segment each medical image by way of trained detectors into image regions, each segmented image region being annotated automatically with annotation data and stored in an annotation database; and
at least one user terminal, connected to the processing unit, to load at least one selected medical image from said image database and to retrieve corresponding annotation data of all segmented image regions of said at least one selected medical image from said annotation database for further annotation of said at least one selected medical image of said patient.

21. An apparatus development system for development of at least one complex apparatus including a plurality of interlinked electromechanical entities, said apparatus development system comprising:
an image annotation system according to claim 1 for annotation of images of said complex apparatus.

22. A security system for detecting at least one entity within images, said security system comprising:
an image annotation system according to claim 1 for annotation of images.

23. A method for annotation of an image, comprising:
parsing an image retrieved from an image database and segmenting said retrieved image, using trained detectors, into image regions, each segmented image region being annotated automatically with annotation data and being stored in an annotation database; and
selecting an image from said image database and retrieving corresponding annotation data of all segmented image regions of said selected image from said annotation database for further annotation of said selected image.

24. An annotation tool for annotation of an image, said annotation tool loading at least one selected image from an image database and retrieving corresponding annotation data of segmented image regions of said image from an annotation database for further annotation.

25. A computer program comprising instructions for performing the method of claim 23.

26. A data carrier which stores the computer program of claim 25.

27. The image annotation system according to claim 2, wherein said image database stores a plurality of two-dimensional or three-dimensional images, said images comprising at least one of:
magnetic resonance image data provided by a magnetic resonance scanning apparatus,
computer tomography data provided by a computer tomograph apparatus,
x-ray image data provided by an x-ray apparatus, ultrasonic image data provided by a ultrasonic machine, and
photographic data provided by a camera.

28. The image annotation system according claims 16, wherein the annotated data of at least one image of a patient is processed by a data processing unit to generate automatically an image finding record of said image.

29. An apparatus development system for development of at least one complex apparatus including a plurality of interlinked electromechanical entities, said apparatus development system comprising:
an image annotation system according to claim 20 for annotation of images of said complex apparatus.

30. A security system for detecting at least one entity within images, said security system comprising:
an image annotation system according to claim 20 for annotation of images.

31. A computer readable medium including program segments for, when executed on a computer device, causing, the computer device to implement the method of claim 23.
